(19) United States
(12) Patent Application Publication
(10) Pub. No.: US 2010/0027899 A1
(43) Pub. Date: Feb. 4, 2010

(54) DATA ENCODING SYSTEM, METHOD THEREOF AND DIGITAL IMAGE CAPTURING DEVICE USING SAME

(75) Inventor: CHANG-CHIANG LIN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/346,890

(22) Filed: Dec. 31, 2008

(30) Foreign Application Priority Data
Jul. 31, 2008 (CN) 200810303296.9

(51) Int. Cl. G06K 9/46

(52) U.S. Cl. 382/236

(57) ABSTRACT

A data encoding system for encoding image data in a buffer includes a codec, a ratio calculator, and a controller. The codec is configured for reading the image data from the buffer in parts, encoding the read parts of the image data using a compression ratio, and writing the encoded parts back to the buffer. The ratio calculator is configured for calculating a first ratio of the size of the encoded parts to the amount of free space of the buffer before any part of the image data was encoded, and a second ratio of size of the read parts to that of the entire image data. The controller determines whether the first ratio is larger than the second ratio, increasing the compression ratio if the first ratio is larger than the second ratio, and controlling the codec to re-encode the image data using the increased compression ratio.

### BACKGROUND

1. Technical Field

The present disclosure relates to data processing technology and, particularly, to a data encoding system and an encoding method, and a digital image capturing device using the system and/or the method.

2. Description of the Related Art

Digital image capturing devices, such as digital still cameras and camcorders, typically include a solid imaging element configured for obtaining digital image data and a buffer for buffering the image data. Commonly, the digital image capturing devices further include a permanent storage unit for storing the digital image data and a data encoding system configured for encoding the digital image data before storing it in a permanent storage unit. The encoding system reads part(s) of the digital image data from the buffer, encodes the read part(s), and writes the encoded part(s) back to the buffer. After all of the digital image data has been encoded, then it is stored in the permanent storage unit.

Being limited to the buffer capacity, it is not uncommon that the free space of the buffer is not enough to store the encoded image data which is encoded using a small compression ratio. In this case, the encoding system needs to increase the compression ratio and re-encode the digital image data. This is time-consuming.

Therefore, what is needed is to provide a data encoding system and method for use in a digital image capturing device which can overcome the above-mentioned problem.

### BRIEF DESCRIPTION OF THE DRAWINGS

FIG. 1 is a functional block diagram of a digital image capturing device which includes a data encoding system, according to an exemplary embodiment.

FIG. 2 is a flowchart of an encoding method, according to another exemplary embodiment.

### DETAILED DESCRIPTION OF THE EMBODIMENTS

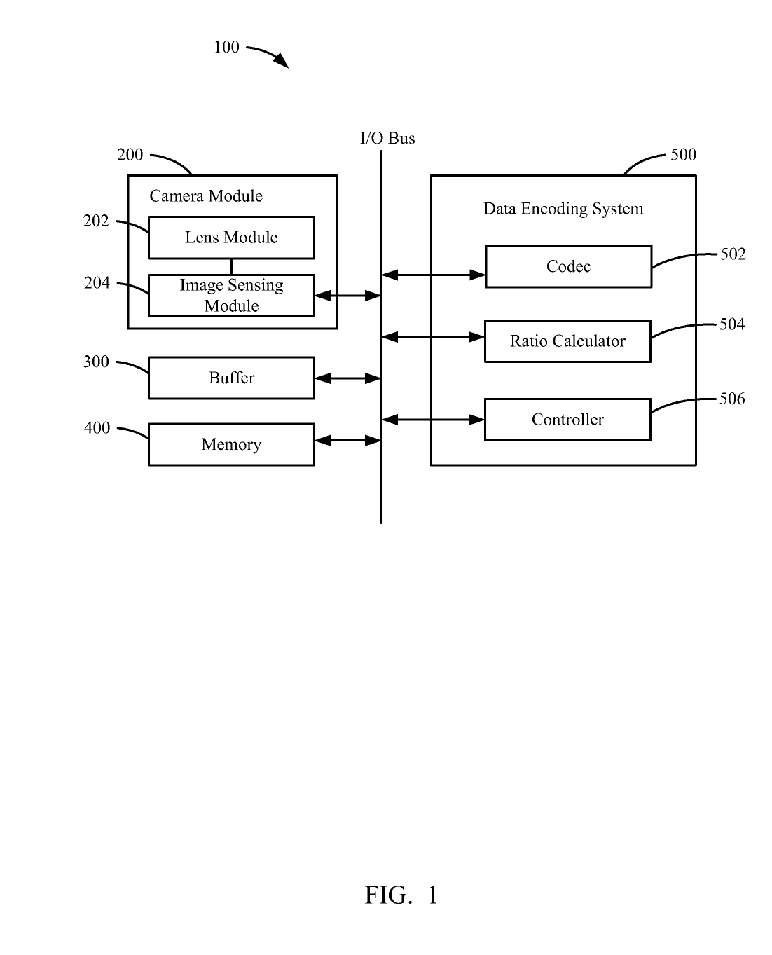

Referring to FIG. 1, a digital image capturing device 100, such as a digital still camera, according to an exemplary embodiment includes a camera module 200, a buffer 300, a memory 400, and a data encoding system 500.

The camera module 200 includes a lens module 202 and an image sensing module 204. The lens module 200 is configured for focusing light onto the image sensing module 204. The image sensing module 204, such as a charge-coupled device (CCD), is configured for converting the focused light into corresponding image data. In addition to the lens module 202 and the image sensing module 204, the camera module 200 may also include required controlling units and various image processing units. The controlling units may include auto-focus, auto-exposure, and auto-white-balance controlling units, and are configured for controlling corresponding aspects of the camera module 200. The image processing units may include an analog-to-digital converter, a color space converting unit, and a gamma correcting unit, and are configured for processing the image data for various intentions.

The buffer 300 is for buffering data being processed for the digital image capturing device 100.

The memory 400 is typically a permanent storage, and is for permanently storing data.

The data encoding system 500 is configured for reading the image data from the buffer 300, encoding the image data, and writing the encoded image data back to the buffer 300. The data encoding system 500 includes a codec 502, a ratio calculator 504, and a controller 506. The codec 502 is configured for reading the image data from the buffer 300 in parts, encoding the read parts of the image data using a compression ratio, and writing the encoded parts back to the buffer 300. The ratio calculator 504 is configured for calculating a first ratio of the size of the encoded parts to the amount of free space of the buffer 300 before any part of the image data was encoded, and a second ratio of size of the read parts to that of the entire image data. The controller 506 is configured for determining whether the first ratio is larger than the second ratio, increasing the compression ratio if the first ratio is larger than the second ratio, and controlling the codec 502 to re-encode the image data using the increased compression ratio. For example, the codec 502 may be a joint photographic experts group (JPEG) encoder.

The digital image capturing device 100 using the encoding system 500 can dynamically determine whether free space of the buffer is enough for the image data at a current compression ratio and adjust, if needed, the compression ratio for encoding the image data. Thereby, encoding time can be reduced.

Various components of the digital image capturing device 100 such as the ratio calculator 504, the controller 506 can be individual electrical elements, or alternatively integrated into a central control unit. The components can connect to each other by an input/output (I/O) bus. Also, some components can be software modules written in a variety of computer languages such as C#, Visual C++, Visual Basic, C++, and so on.

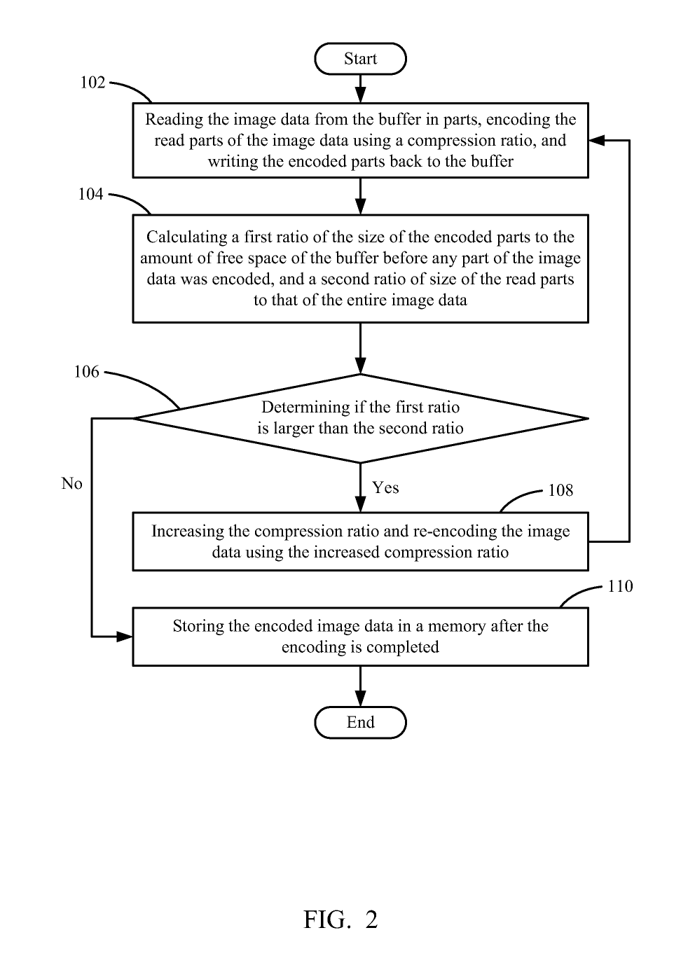

Referring to FIG. 2, a data encoding method for encoding image data in the buffer 300 includes step 102 through step 110 carried out by the digital image capturing device 100. Step 102: reading the image data from the buffer in parts, encoding the read parts of the image data using a compression ratio, and writing the encoded parts back to the buffer. Step 104: calculating a first ratio of the size of the encoded parts to the amount of free space of the buffer before any part of the image data was encoded, and a second ratio of size of the read parts to that of the entire image data. Step 106: determining whether the first ratio is larger than the second ratio. Step 108: increasing the compression ratio if the first ratio is larger than the second ratio and re-encoding the image data using the increased compression ratio. Step 110: storing the encoded image data in the memory after the encoding is completed if the first ratio is no larger than the second ratio.

It is to be understood, however, that even though numerous characteristics and advantages of the present disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A data encoding system for encoding image data in a buffer, the system comprising:
a codec configured for reading the image data from the buffer in parts, encoding the read parts of the image data using a compression ratio, and writing the encoded parts back to the buffer;
a ratio calculator configured for calculating a first ratio of the size of the encoded parts to the amount of free space of the buffer before any part of the image data was encoded, and a second ratio of size of the read parts to that of the entire image data; and
a controller configured for determining whether the first ratio is larger than the second ratio, increasing the compression ratio if the first ratio is larger than the second ratio, and controlling the codec to re-encode the image data using the increased compression ratio.

2. The system as claimed in claim 1, wherein the codec is a joint photographic experts group encoder.

3. A data encoding method for encoding image data in a buffer, the method comprising:
reading of the image data from the buffer in parts, encoding the read parts of the image data using a compression ratio, and writing the encoded parts back to the buffer;
calculating a first ratio of the size of the encoded parts to the amount of free space of the buffer before any part of the image data was encoded, and a second ratio of size of the read parts to that of the entire image data;
determining whether the first ratio is larger than the second ratio; and
increasing the compression ratio if the first ratio is larger than the second ratio, and re-encoding the image data using the increased compression ratio.

4. The method as claimed in claim 3, further comprising: storing the encoded image data in a memory after the encoding is completed.

5. A digital image capturing device comprising:
a camera module for capturing image data;
a buffer for buffering the image data;
a memory for storing the image data; and
a data encoding system comprising:
a codec configured for reading the image data from the buffer in parts, encoding the read parts of the image data using a compression ratio, and writing the encoded parts back to the buffer;
a ratio calculator configured for calculating a first ratio of the size of the encoded parts to the amount of the free space of the buffer before any part of the image data was encoded, and a second ratio of size of the read parts to that of the entire image data; and
a controller configured for determining whether the first ratio is larger than the second ratio, increasing the compression ratio if the first ratio is larger than the second ratio, and controlling the codec to re-encode the image data using the increased compression ratio.

6. The device as claimed in claim 5, wherein the camera module comprises a lens module configured for focusing light and an image sensing module configured for converting the focused light into corresponding image data.
